(19) United States
(12) Patent Application Publication
(10) Pub. No.: US 2009/0272283 A1
(43) Pub. Date: Nov. 5, 2009

(54) Devices Used for the Production of a Product

(76) Inventors: Kurt Anton Heublein, Zellingen (DE); Burkard Otto Herbert, Wurzburg (DE); Bernhard Walter Muth, Wurzburg (DE); Stefan Wander, Helmstadt (DE)

Correspondence Address: JONES, TULLAR & COOPER, P.C., P.O. BOX 2266 EADS STATION, ARLINGTON, VA, 22202, US

(21) Appl. No.: 11/887,728

(22) PCT Filed: Mar. 14, 2006
(86) PCT No.: PCT/EP2006/060704

§ 371 Date: Jan. 3, 2008

(30) Foreign Application Priority Data
Apr. 5, 2005 (DE) 10 2005 015 701.7
Jul. 2, 2005 (DE) 10 2005 031 010.9

(51) Int. Cl. B41F 31/00

(52) U.S. Cl. 101/141

(57) ABSTRACT

A product of a web-processing machine includes at least one partial product which is combined in a first format. Another partial product is combined in a second format that is different from the first format. When the two partial products are combined in a final product, one of the partial products protrudes from the other partial product.

### CROSS-REFERENCE TO RELATED APPLICATIONS

This application is the U.S. national phase, under 35 USC 371, of PCT/EP2006/060704, filed Mar. 14, 2006; published as WO 2006/133979 A2 and A3 on Dec. 21, 2006 and claiming priority to DE 10 2005 015 701.7, filed Apr. 5, 2005 and to DE 10 2005 031 010.9 filed Jul. 2, 2005, the disclosures of which are expressly incorporated herein by reference.

### FIELD OF THE INVENTION

The present invention is directed to devices used for the production of a product. A printing press is provided with at least one printing group having a forme cylinder and one further processing stage which includes a former. The former is used for generating longitudinal folds in the printed product.

### BACKGROUND OF THE INVENTION

From DE 198 03 809 A1, a printing press is known, which, in one embodiment, is used to produce printed products in broadsheet format. In an alternative embodiment, the printing press is used to produce printed products in tabloid format.

EP 0 111 170 B1 describes a printed product and a method for producing such printed products. In a product, which is comprised of a plurality of sheets placed one on top of another, one sheet, with a marginal strip, is configured to extend laterally beyond the others. This marginal strip serves to simplify the mechanical opening of the product, and is cut away at the end of production.

EP 1 037 749 B1 describes a printed product, in which the assembled product, in addition to including printed pages having the original external dimensions, also has narrower printed pages. This page arrangement serves to eliminate “filler pages” and is achieved, for example, in that the narrower pages allow the total surface of the product to be steplessly varied. This printed product can be applied to a broadsheet product, to a tabloid product, to a magazine product, and the like.

DE 100 03 025 C1 describes a longitudinal folding device for use in longitudinally folding paper webs of different widths. The fold former, together with the associated folding rollers, the former feed roller and the longitudinal cutting device, can be displaced in a frame in a direction which is transverse, or crosswise to the direction of web travel.

### SUMMARY OF THE INVENTION

The object of the present invention is directed to the provision of devices used for the production of a product that is comprised of product sections of different formats.

The object is attained in accordance with the present invention by the provision of a device for producing a product in a printing press that has at least one printing group, having a forme cylinder, and at least one further processing state which has longitudinal fold formers. The forme cylinder, in an axial direction, has at least one print image having a first page length and a second print image having a second page length different from the first. One image can be a vertical newspaper page in broadsheet format. The other image can be a horizontal printed page in tabloid format.

The benefits to be achieved in accordance with the present invention consist, in particular in that product, especially printed product, that provides the viewer with an expanded informational content and/or with an improved overview of the contents, even when the printed product is closed, is formed. It is also advantageous that the finished product is configured to be multifunctional. The consumer is able to identify product sections of the final product and can also easily identify their contents and can thus remove these product sections in a simple manner. This is due to the extension of one product section beyond another other product section.

### BRIEF DESCRIPTION OF THE DRAWINGS

Preferred embodiments of the present invention are represented in the drawings and will be described in greater detail below.

The drawings show:

FIGS. 1a), 1b) and 1c) depict an example of a mixed product in accordance with the present invention and comprised of broadsheet and tabloid sections, wherein FIG. 1a) is a front view, FIG. 1b) is a plan view and FIG. 1c) is a perspective view;

FIG. 2 a schematic representation of a device for producing the product in accordance with the present invention and with a web width that is greater than or equal to six newspaper pages in broadsheet format, but smaller than seven newspaper pages in the same broadsheet format arranged side by side, in a first preferred embodiment;

FIG. 3 a schematic representation of a device for producing the product in accordance with present invention and with a web width that is greater than or equal to six newspaper pages in broadsheet format, but smaller than seven newspaper pages of the same broadsheet format arranged side by side, in a second preferred embodiment;

FIG. 4 a schematic representation of a device for producing the product in accordance with present invention and with a web width that is greater than or equal to four newspaper pages in broadsheet format, but smaller than five newspaper pages of the same broadsheet format arranged side by side;

FIG. 5 a schematic representation of a device for producing the product in accordance with present invention and with a web width that is greater than or equal to two newspaper pages in broadsheet format, but smaller than three newspaper pages in the same broadsheet format arranged side by side;

FIGS. 6a) and 6b) a side view of two formers which, in FIG. 6a) are displaced toward one another and which, in FIG. 6b) depict the resulting product section position;

FIGS. 7a), 7b) and 7c) an example of a mixed product in accordance with present invention and comprised of tabloid sections of different page depths, wherein FIG. 7a) is a front view, FIG. 7b) is a a plan view and FIG. 7c) is a perspective representation; and

FIG. 8 an example showing the arrangement of the print images and/or formers that is representative of the formats in FIG. 7.

### DESCRIPTION OF THE PREFERRED EMBODIMENTS

A finished printed product, in accordance with the present invention, is comprised of product sections, wherein at least one of the product sections is intentionally provided with a significant lateral extension. The word “significant” is used to indicate that this lateral extension does not include differences in product sections that are generated as a result of printing or folding imprecision, through the formation of folding spines, or to improve grasping of a section and intended for subsequent cutting off. A significant lateral extension refers instead to a difference in lateral product section extensions that is greater than 10 mm, more particularly greater than 20 mm, and especially greater than 30 mm. It is particularly advantageous for the difference in product lateral extensions to correspond to the height of at least one line of text in the printed, extended product section, so that, as indicated in the various drawing figures, the viewer of the resultant multi-section printed product is able to discern the at least one line of text on the extended product section, when that extended product section is included in the assembled finished product. The finished product is preferably printed on at least one side in the area of the product section extension. With this arrangement, when the product is assembled, the line of text on the extended product section is discernible to the viewer on the side of the finished product. The finished product therefore provides the viewer with expanded informational content and/or an improved overview of the contents of the finished product, even when it is closed.

In a first preferred embodiment of the present invention, the finished product is comprised of at least one product section in broadsheet format and of at least one product section in tabloid format. In a second preferred embodiment of the present invention, the final product has two product sections in different tabloid formats, such as, for example, two product sections in tabloid formats and each having different page depths.

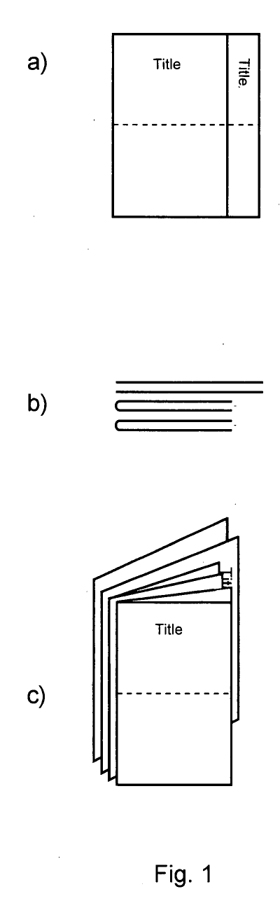

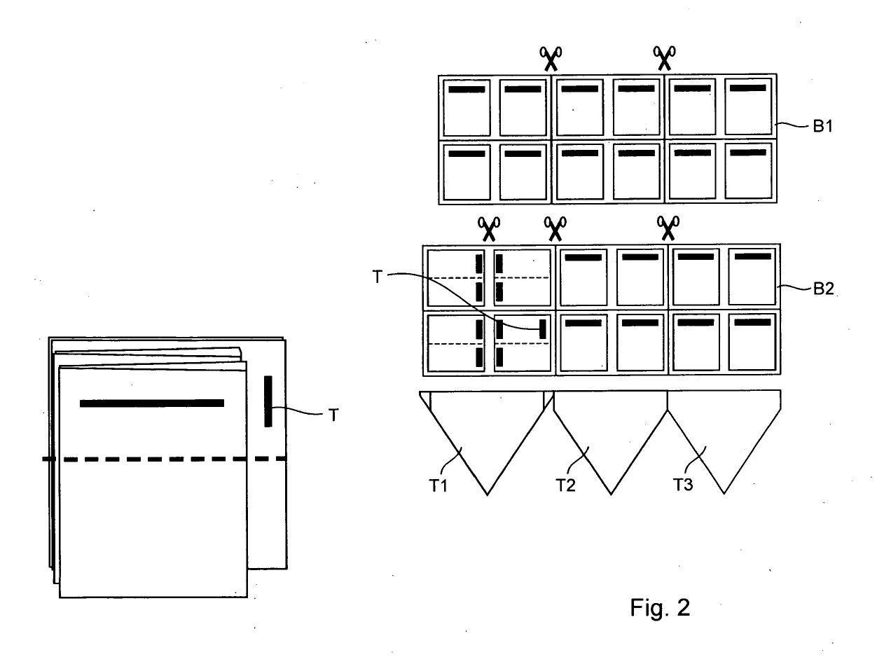

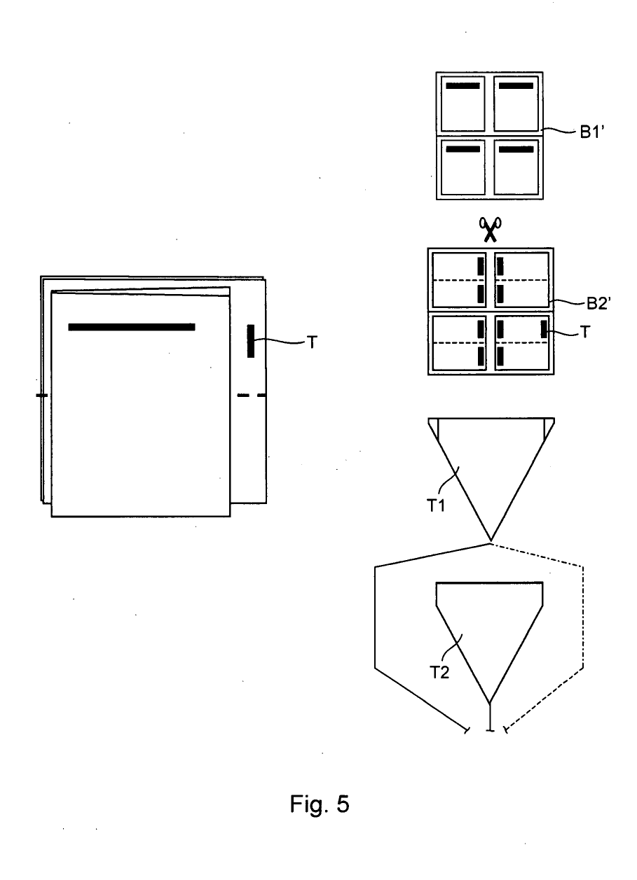

Referring initially to FIG. 1a) through c), there is shown a schematic view of a finished, assembled product produced, for example, using a device as shown in FIG. 2. This finished, assembled product is characterized in that the finished, assembled product contains at least one product section or “book” in broadsheet format and at least one product section or “book” in tabloid format. The page orientations of the product sections in the respective tabloid and broadsheet formats are perpendicular to one another, which page orientations are indicated symbolically in FIGS. 2, 3, 4, 5 and 8 by a bar that symbolizes the title. Also shown in FIGS. 2 and 5 by way of example, in the unrolling of the page imposition on the web B2; B2′, is an optionally printed line of text T, for example a title T, which, in the finished product, protrudes laterally.

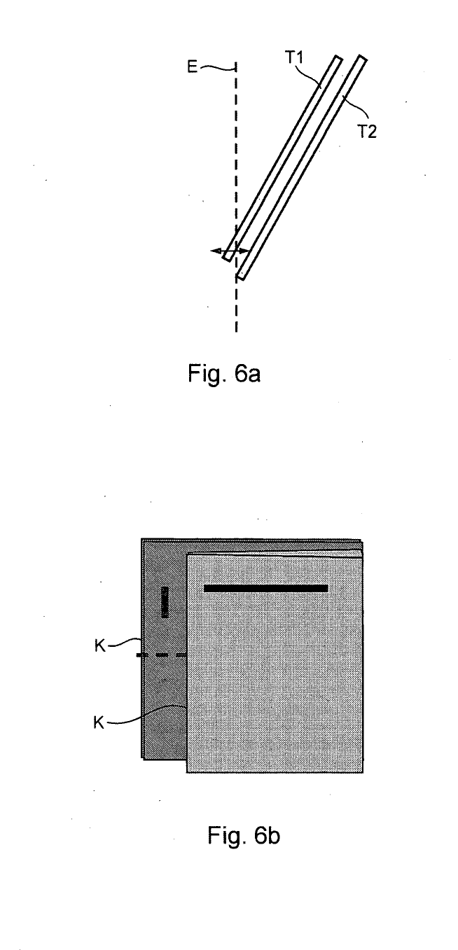

The finished, assembled product shown in FIG. 1 is especially characterized in that a length of a tabloid product section is not equal to a width of a broadsheet product section. As can be seen in FIGS. 6a) and 6c), one of the product sections extends laterally in relation to the other. In one advantageous preferred embodiment of the present invention, as represented in FIG. 1, the length, or the page depth of the tabloid product section is significantly greater than the width of the broadsheet product section. Once the relevant products have been assembled, the tabloid product section has a significant lateral extension. With regard to the definition of the term “significant”, please review the discussion which is set forth above. It is advantageous for the difference to correspond to at least the height of one line of text on the printed tabloid product section, so that, as shown in FIG. 1, when the product is assembled, the line of text on the tabloid product section is discernible to the viewer.

In principle, the projection or significant lateral extension, as described, can be provided on the tabloid product section on the open longitudinal side of the broadsheet product section, as shown, or on the side of the longitudinal fold. The latter is advantageous with respect to the page configuration of the tabloid product section, but requires additional expenditure on machinery for production.

In principle, a web-processing machine, and especially a printing press and/or its further processing stage or stages, such as a longitudinal cutting device and/or a former structure, can be configured specifically to produce the above-mentioned product. In one desirable embodiment of the present invention, however, the machine and/or the further processing stage are configured to be convertible such that “normal production,” or production involving a homogeneous product configuration, such as, for example, only broadsheet or only tabloid product sections, or alternatively, the above-described mixed production of the described inhomogeneous product can be generated as needed. In the discussion which follows, schematic embodiments for the alternative production of a “normal” product and the mixed product are schematically represented.

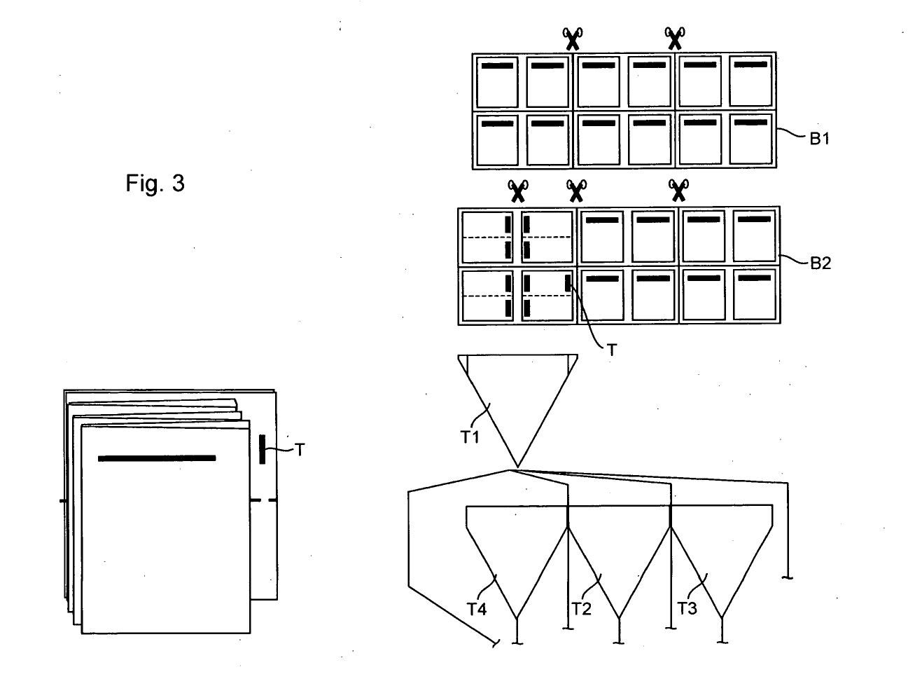

In the upper areas of FIGS. 2 and 3, page impositions of two material webs B1; B2 of different widths, such as, for example, webs B1; B2, are represented schematically, wherein the upper imposition of a web B1 corresponds to an imposition having six newspaper pages in broadsheet format arranged side by side. In this manner, and for printing these six pages, six print images are also arranged on a forme cylinder of a preceding printing group, which is not shown here, and which forme cylinder is at least as long, in an axial direction as these six newspaper pages arranged side by side. Such a printing press is typically referred to as a “triple-width” printing press. In normal production, the first web B1 is cut longitudinally into three web sections of essentially equal widths for further processing, before being fed to subsequent fold formers T1; T2; T3, which, in short, are fold formers T1; T2; T3, that are usable for generating longitudinal folds in the web sections cut from web B1. In this arrangement, the effective width of each former T1; T2; T3 corresponds to the width of two broadsheet pages. The formers T1; T2; T3 are preferably arranged side by side such that their former noses are each aligned with the center of the respective web section of the now longitudinally severed web B1.

In order to generate an inhomogeneous product, as has been described above, and with an extension on one of the product sections, in this case the tabloid product section while maintaining the width of the other product section, in this case the broadsheet product section, for example a second web B2 is processed, which second web B2 is wider than is the first web B1, which constitutes six newspaper pages in broadsheet format arranged side by side. Accordingly, in a machine of this type the previously described forme cylinder, or its effective barrel length, is advantageously configured to be wider by a corresponding amount, such as, for example, at least 20 mm, advantageously at least 40 mm, especially at least 60 mm, than would correspond to the width of the number of broadsheet pages to be printed.

If an extension on the tabloid product section is to be arranged on the side of a fold spine of the broadsheet product section, at least one of the formers T1; T2; T3, and especially the former T1 that is allocated to the longitudinal fold former of the tabloid product section, should be capable of moving in a direction such that its former nose, as viewed from the side, can optionally be placed in a plane E with the other former nose or noses, or can be moved out of alignment with such a plane E, as may be seen in FIG. 6a. If the former noses do not lie within the same plane E, then the fold edges K, such as a fold spine with an uncut partial strand and an “open” fold spine with a partial strand cut in half are displaced by the amount of shift, all as may be seen in FIG. 6b.

In an advantageous first variation of a first embodiment of the present invention as depicted in FIG. 2, at least one of the three formers T1; T2; T3, and especially the former T1 that is aligned with the partial web of the tabloid product section of the web B2, is configured so as to be capable of moving crosswise to the direction of feed of the web B1; B2, so that its former nose will be in alignment with the center of the partial web of the now wider tabloid product section. Additionally, the effective width of the former T1, that is allocated to the tabloid product section, can also be adjustable, so that it is narrower, at least on its side which is adjacent to a second former T2, in an operational position in which broadsheet pages are folded, than it would be in an operational position in which the above-referenced tabloid pages are folded. This can be achieved, such as, for example, by using optionally insertable and/or removable extension pieces, which extension pieces are positioned and/or are removed or swung out depending upon the type of production. Additionally, a longitudinal cutting device shown in FIGS. 2 and 3 is preferably provided, which is aligned with the center of the former T1 that is allocated to the tabloid product section.

In a second variation of the preferred first embodiment, as shown in FIG. 3, three formers T4; T2; T3 are structured to be stationary with a fixed effective width solely for use in broadsheet production, with a special former T1 being provided for the previously described mixed production, and with this special former T1 positioned above as shown, below, not shown, or adjacent to, also not shown the other three formers T4; T2; T3. The partial web or webs that have the tabloid format are then guided over the former T1, while the partial webs having the broadsheet pages are guided over the other formers T4; T2; T3. With this embodiment, it is not necessary for the special former T1 to be configured to be adjustable, in terms of its width, and/or to be adjustable in its position crosswise to the direction of web travel and/or to be movable in its position along the longitudinal axis of the machine.

As shown in FIG. 3, the strand of the tabloid product section can be guided in various paths from the special former T1 and around the other formers T4; T2; T3 or between them. Depending upon the selected web path for the tabloid partial web, a mixed product can be produced, wherein the tabloid product section then comes to lie below, as shown at the left in FIG. 3, above or even between the broadsheet product sections.

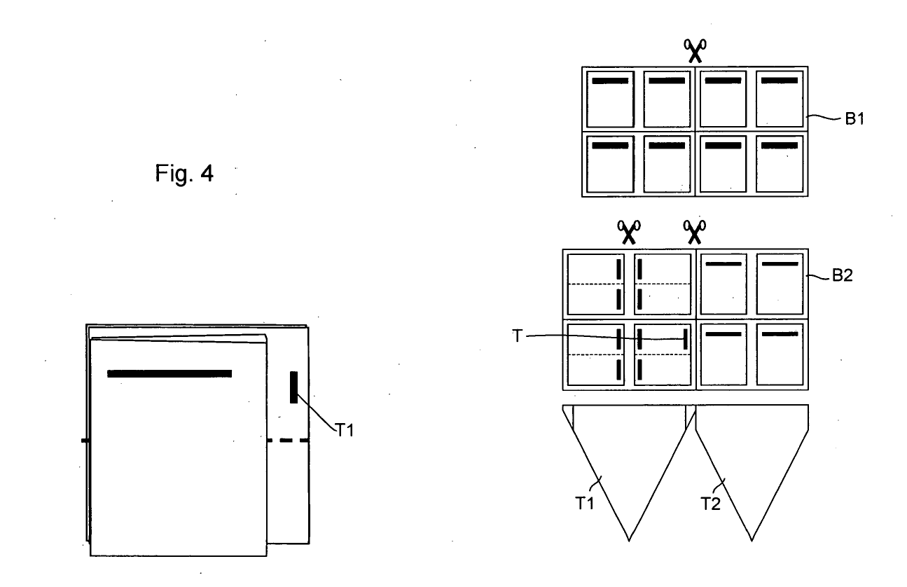

In an upper portion of FIG. 4, page impositions on two webs B1; B2 of different widths are shown schematically. An upper imposition corresponds to an imposition having four newspaper pages in broadsheet format arranged side by side. In this manner, four print images are also arranged on a forme cylinder of a preceding printing group, which is not shown here, and which forme cylinder is at least as long as these four newspaper pages arranged side by side, and thus is referred to as a “double-width” printing press. In normal production, the web B1 is cut longitudinally into two web sections of essentially equal widths for further processing, before being fed to subsequent formers T1; T2 for use in generating longitudinal folds in the two web sections formed from web B1. In this arrangement, the effective width of each former T1; T2 corresponds to the width of two broadsheet pages. The formers T1; T2 are preferably arranged side by side such that their former noses are each aligned with the center of the respective web section formed by longitudinally dividing the web B1.

In order to generate a previously-described inhomogeneous product, with an extension on one of the product sections, and in this case of the tabloid product section while maintaining the width of the other product section, in this case the broadsheet product section using this embodiment of the present invention, as depicted in FIG. 4, for example a second web B2 is processed, which second web B2 is wider than the four newspaper pages in broadsheet format arranged side by side printed on web B1. Accordingly, in a machine of this type the previously discussed forme cylinder, or at least its effective barrel length, is advantageously configured to be wider by a corresponding amount, such as, for example, by at least 20 mm, advantageously by at least 40 mm, and especially by at least 60 mm, than would correspond to the width of the number of broadsheet pages to be printed.

Regarding the configuration of the former T1, and particularly with respect to its ability to move crosswise to the direction of web travel, and/or the adjustability of its effective width, and/or the ability to move its nose out of or into the plane E, the same capabilities as were discussed in reference to the first embodiment for the first variation 1 applies, with the difference that no third former T3 is necessary and/or provided.

In accordance with the second variation variation of the first embodiment, two, such as, for example, two stationary formers T4; T2 can be provided solely for broadsheet production, with one additional, wider former T1 being provided above, below or adjacent to these two stationary formers T4; T2.

In an example according to FIG. 5, and which is depicted in an upper area of FIG. 5, page impositions on two material webs B1′; B2′ of different widths, such as, for example, material webs B1′; B2′, are again shown schematically. An upper imposition corresponds to an imposition with two newspaper pages in broadsheet format being arranged side by side. In this manner, four print images are also arranged on a forme cylinder of a preceding printing group, which printing group is not shown here, and which forme cylinder is at least as long as these two newspaper pages arranged side by side, in what is typically referred to as a “single-width” printing press. In “normal production”, such as, for example, in the homogeneous production of broadsheet product sections, for example at least two webs B1′ of this type can be printed in this manner using at least two corresponding printing groups, and can be assembled to form a homogeneous product.

If a mixed product, as is shown in FIG. 1, is to be produced, for example at least one previously described web B1′ of double broadsheet width is printed using one printing group, and at least one second, wider web B2′ is printed using a second printing group, the imposition of which is also represented in FIG. 5, with the wider web B2′ being printed with two pages in tabloid format arranged side by side. The narrower web B1′, that has the pages in broadsheet format, is then fed to a first former T2, which has an effective width of two broadsheet pages, for example, whereas the wider web B2′ having the pages in tabloid format is guided to the former T1.

The wider web former T1 can be structured similarly the former of the first variation of the first preferred embodiment, with respect to its ability to move crosswise to the direction of web travel and/or with respect to the adjustability of its effective width and/or with respect to its ability to move its nose out of, or into the plane E. However, former T1 can likewise be configured to have a fixed effective width of at least two tabloid page lengths and/or to be incapable of moving crosswise to the web B1; B2 and/or to be configured such that its nose cannot be moved out of or into the plane E, if it is to be used exclusively for the longitudinal folding of the extended tabloid product sections.

The former T1 can be arranged above, below or adjacent to the other former T2.

In the preceding preferred embodiments of the present invention, a forme cylinder of a printing group has, in an axial direction, for example, at least one printing forme that corresponds to the width of a whole-number multiple of the width of one newspaper page in broadsheet format, and one printing forme that corresponds to the width of one whole-number multiple of the length of one printed page in tabloid format.

In all the previously described embodiments of the present invention, in an advantageous configuration, a stitcher or a similar bonding device can be provided in the strand path of the tabloid product section, before this strand is assembled with one or more of the other strands. In an advantageous further variation of the present invention, once the partial strands have been assembled, they can be fed to a folding apparatus, which is not specifically shown here, where they receive a crosswise fold which partial fold is indicated in the figures by dashed lines.

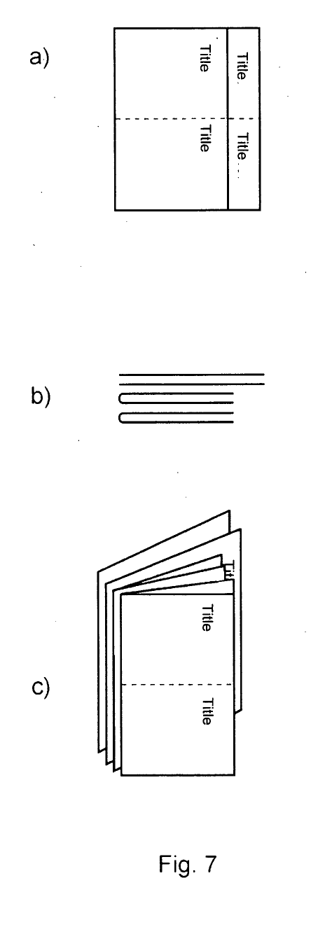

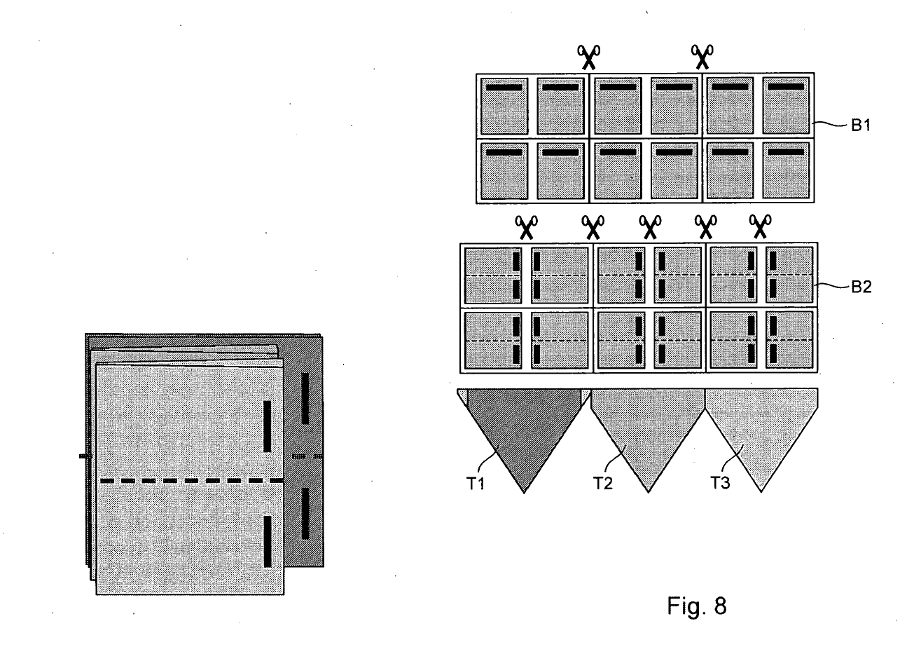

In FIGS. 7 and 8 a preferred embodiment of the present invention is shown wherein the final product has two product sections of different tabloid formats. In this preferred embodiment, FIG. 8 shows a former configuration that corresponds representatively to that of FIG. 2. The contents of FIG. 3 through 6 can be applied in accordance with the preferred embodiment having two tabloid formats, with printed pages arranged horizontally .

While preferred embodiments of devices used for the production of a product in a printing press, in accordance with the present invention, have been set forth fully and completely hereinabove, it will be apparent to one of skill in the art that various changes in, for example, the specific structures of the printing cylinders and printing formes, the arrangements for supporting the longitudinal fold formers and the like could be made without departing from the true spirit and scope of the present invention which is accordingly to be limited only by the appended claims.

What is claimed is:

1-15. (canceled)

16. A device for producing a printed product in a printing press comprising:
at least one printing group;
at least one forme cylinder in said at least one printing group;
a further processing stage including formers adapted to form longitudinal folds in webs passing through said further processing stage; and
at least one print image of a vertical newspaper page in a first, broadsheet format and at least one print image of a horizontal printed page in a second, tabloid format side by side on said forme cylinder in an axial direction of said forme cylinder.

17. The device of claim 16 wherein said horizontal printed page in said second, tabloid format has a length and wherein said vertical newspaper page in said first, broadsheet format has a width, said length being greater than said width.

18. A device for producing a printed product in a printing press comprising:
at least one printing group;
at least one forme cylinder in said at least one printing group;
a further processing stage including formers adapted to form longitudinal folds in webs passing through said further processing stage;
at least one printing forme on said forme cylinder; and
a first print image of a first tabloid format having a first page length and a second print image format having a second page length, different from said first page length, axially side by side on said forme cylinder.

19. The device of claim 16 wherein there are at least first and second formers in said further processing stage.

20. The device of claim 18 wherein there are at least first and second formers in said further processing stage.

21. The device of claim 19 wherein at least one of said at least first and second formers is movable transversely to a direction of web travel in said further processing stage.

22. The device of claim 20 wherein at least one of said at least first and second formers is movable transversely to a direction of web travel in said further processing stage.

23. The device of claim 19 wherein at least one of said at least first and second formers has an adjustable effective width.

24. The device of claim 20 wherein at least one of said at least first and second formers has an adjustable effective width.

25. The device of claim 19 wherein at least one of said at least first and second formers is movable into and out of a plane defined by a former nose of at least another of said at least first and second formers.

26. The device of claim 20 wherein at least one of said at least first and second formers is movable into and out of a plane defined by a former nose of at least another of said at least first and second formers.

27. The device of claim 19 further including a stitcher in a web path after, in a direction of web travel, at least one of said at least first and second formers.

28. The device of claim 20 further including a stitcher in a web path after, in a direction of web travel, at least one of said at least first and second formers.

29. The device of claim 16 further including web strands with printed images in at least said first and second formats guided over at least one of said formers and assembled to form a strand.

30. The device of claim 18 further including web strands with printed images in at least said first and second formats guided over at least one of said formers and assembled to form a strand.

31. The device of claim 16 further including at least one first printing forme on said at least one forme cylinder, in said axial direction, said at least one first printing forme having a forme width corresponding to a width of a whole-number of said vertical newspaper pages in said first broadsheet format and one second printing forme having a forme width corresponding to a width of a whole-number multiple of a length of one page printed in said second, tabloid format, said at least one first printing forme and said one second printing forme being arranged side by side in said axial direction of said forme cylinder.
